(19) United States
(12) Patent Application Publication
(10) Pub. No.: US 2010/0092599 A1
(43) Pub. Date: Apr. 15, 2010

(54) Complementary Alignment Marks for Imprint Lithography

(75) Inventors: Kosta S. Selinidis, Austin, TX (US); Gerard M. Schmid, Austin, TX (US); Ecron D. Thompson, Round Rock, TX (US); Ian Matthew McMackin, Austin, TX (US); Douglas J. Resnick, Leander, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/575,834

(22) Filed: Oct. 8, 2009

Related U.S. Application Data
(60) Provisional application No. 61/104,308, filed on Oct. 10, 2008.
(60) Provisional application No. 61/144,013, filed on Jan. 12, 2009.

(51) Int. Cl. B29C 59/00

(52) U.S. Cl. 425/470

(57) ABSTRACT

Systems and methods for minimizing overlay error during alignment of a template with a substrate are described. Templates generally include two distinct types of alignment marks: buried alignment marks and complementary alignment marks. Buried marks may be fabricated separately from the patterning surface, and the complementary marks may be fabricated in the same step as the patterning surface.

### CROSS-REFERENCE TO RELATED APPLICATIONS

This application claims the benefit under 35 U.S.C. §119(e)(1) of U.S. Provisional No. 61/104,308 filed on Oct. 10, 2008 and U.S. Provisional No. 61/144,013 filed on Jan. 12, 2009, both of which are hereby incorporated by reference herein in their entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No 2004/0065976, U.S. Patent Publication No. 2004/0065252, and U.S. Pat. No. 6,936,194, all of which are hereby incorporated by reference herein.

An imprint lithography technique disclosed in each of the aforementioned U.S. patent publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that features and advantages of the present invention can be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a simplified side view of the substrate illustrated in FIG. 1, having a patterned layer thereon.

FIG. 3 illustrates an exemplary template corner utilizing a trench structure and the resulting patterned layer formed on the substrate.

FIG. 4 illustrates a simplified side view of an exemplary template having implanted structures.

FIG. 5 illustrates a graphical representation of the index of refraction for an organic imprint resist material, fused silica, and multiple metal oxides.

FIGS. 6A-6E illustrate exemplary formation of a template having implanted structures.

FIGS. 7A-7E illustrate exemplary formation of a template having implanted structures.

FIGS. 8A-8D illustrate exemplary formation of a template having implanted structures.

FIGS. 9A-9E illustrate exemplary formation of a template having implanted structures.

FIGS. 10A-10F illustrate exemplary formation of a template having implanted structures.

FIG. 11 illustrates a side view of the template illustrated in FIG. 1, having buried alignment marks and complementary alignment marks in accordance with embodiments of the present invention.

FIG. 12 illustrates a side view of the template illustrated in FIG. 12, spaced apart from a substrate.

FIG. 13 illustrates a flow chart of an exemplary method for minimizing overlay error during alignment of a template and a substrate.

FIGS. 14A-14N illustrate simplified side views of an exemplary method of formation of a replica template having buried alignment marks and complementary alignment marks.

FIGS. 15A-15L illustrate simplified side views of another exemplary method of formation of a replica template having buried alignment marks and complementary alignment marks.

FIGS. 16A-16K illustrate simplified side views of another exemplary method of formation of a replica template having buried alignment marks and complementary alignment marks.

### DETAILED DESCRIPTION

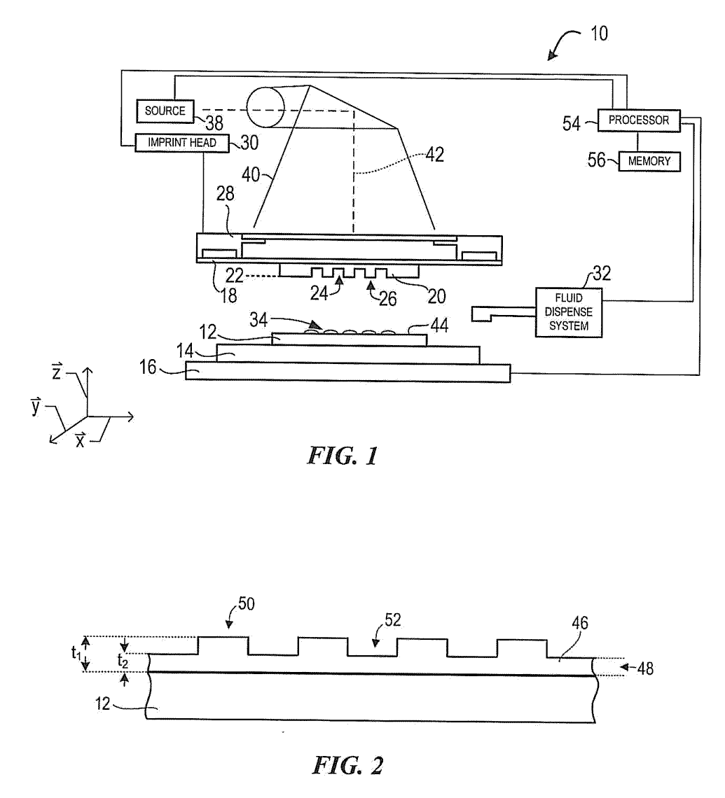

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide translational and/or rotational motion along the x, y, and z-axes. Stage 16, substrate 12, and substrate chuck 14 may also be positioned on a base (not shown).

Spaced-apart from substrate 12 is template 18. Template 18 may include a body having a first side and a second side with one side having a mesa 20 extending therefrom towards substrate 12. Mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations (e.g., planar surface). Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit formable material 34 (e.g., polymerizable material) on substrate 12. Formable material 34 may be positioned upon substrate 12 using techniques, such as, drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. Formable material 34 may be functional nano-particles having use within the bio-domain, solar cell industry, battery industry, and/or other industries requiring a functional nano-particle. For example, formable material 34 may comprise a monomer mixture as described in U.S. Pat. No. 7,157,036 and U.S. Patent Publication No. 2005/0187339, both of which are herein incorporated by reference. Alternatively, formable material 34 may include, but is not limited to, biomaterials (e.g., PEG), solar cell materials (e.g., N-type, P-type materials), and/or the like.

Referring to FIGS. 1 and 2, system 10 may further comprise energy source 38 coupled to direct energy 40 along path 42. Imprint head 30 and stage may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g., ultraviolet radiation, causing formable material 34 to solidify and/or cross-link conforming to a shape of surface 44 of substrate 12 and patterning surface 22, defining patterned layer 46 on substrate 12. Patterned layer 46 may comprise a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

Ascertaining a desired alignment between template 18 and substrate 12 may aid in the facilitation of pattern transfer between template 18 and substrate 12. For example, exemplary alignment systems and processes that may aid in the facilitation of pattern transfer are further described in U.S. Ser. No. 12/175,258, U.S. Ser. No. 11/695,850, U.S. Ser. No. 11/347,198, U.S. Ser. No. 11/373,533, U.S. Ser. No. 10/670,980, U.S. Ser. No. 10/210,894, and U.S. Ser. No. 10/210,780, all of which are hereby incorporated by reference herein in their entirety.

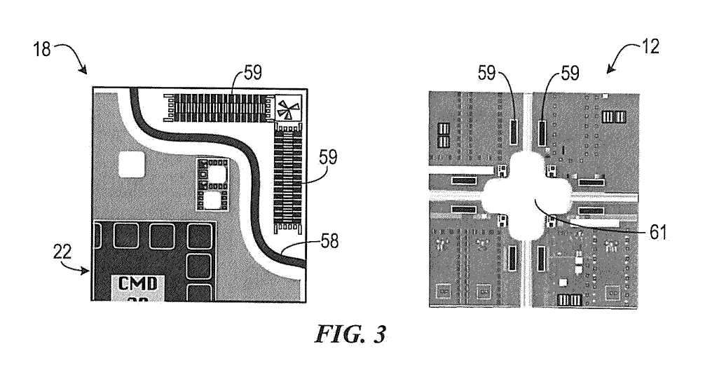

Referring to FIG. 3, alignment systems, such as those referenced above, generally include marks 59 formed on template 18 or adjacent patterning surface 22 during the same patterning step as the features of template 18 (e.g., recesses 24 and/or protrusions 26). Mold 20 (e.g., fused silica) and formable material 34, however, may have similar indices of refraction in the range of wavelengths used for alignment. The similar indices of refraction may cause marks 59 to lose visible contrast when the formable material 34 covers marks 59.

To compensate for such loss of visible contrast, a trench 58 may be used to isolate marks 59 from patterning surface 22 subsequent to deposition of formable material 34 during the imprinting process described with reference to FIGS. 1 and 2. Exemplary trenches 58 are further described in detail in U.S. Pat. No. 7,309,225, which is hereby incorporated by reference. The minimum space needed for trench 58 may be generally large due to the width of trench 58 and/or the distance needed between marks 59 and edges of the patterning surface 22. As such, trench 58 may result in a large open area 61 on substrate 12.

Systems and methods to provide visual contrast for alignment prior or subsequent to deposition of formable material 34 during the imprinting process described with reference to FIGS. 1 and 2 are described herein. Such systems and methods minimize and/or eliminate large open areas 61 (e.g., areas resulting from trenches 58) on substrate 12 while providing suitable alignment between template 18 and substrate 12 for imprinting.

### Implantation

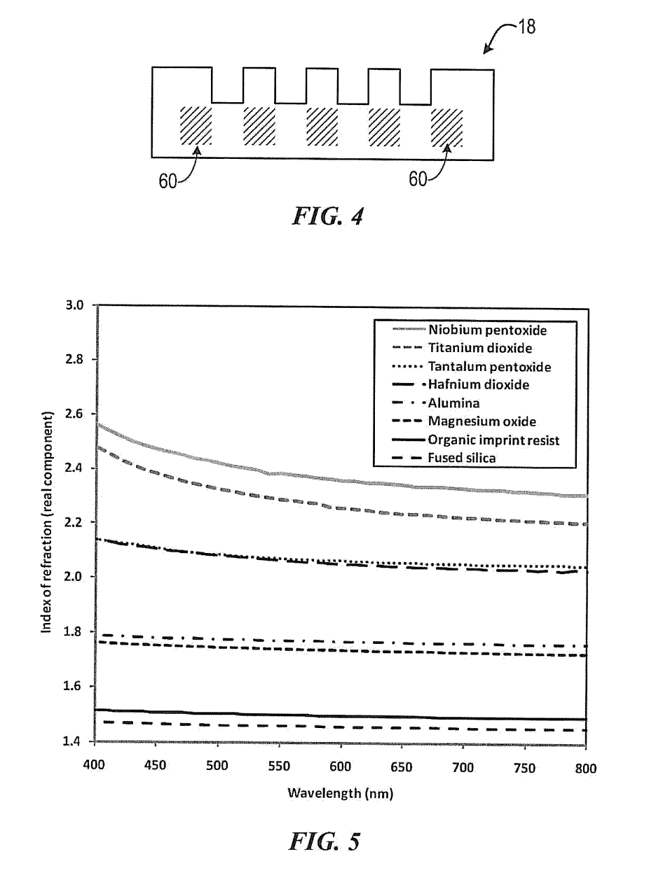

Referring to FIG. 4, an implantation process may provide for implanted structures 60 within template 18 and/or substrate 12. Such implanted structure 60 may provide visual contrast for alignment prior or subsequent to deposition of formable material 34 during the imprinting process described with reference to FIGS. 1 and 2. Implanted structure 60 may be used as alignment marks, and/or implanted structures 60 may enhance alignment marks within template 18. For example, implanted structure 60 may be used in conjunction with complementary alignment marks as described herein.

For simplicity in description, the implantation process is described relative toward template 18; however, it should be obvious to one skilled in the art the same procedures may be used to form implanted structure 60 in substrate 12.

Implanted structure 60 may be formed within template 18 through modification of optical properties of template 18. For example, implantation processes may deposit material within template 18 by accelerating material toward template 18 under an applied field to form implanted structure 60. Exemplary implantation processes include, but are not limited to, U.S. Pat. No. 5,208,125, U.S. Pat. No., 5,217,830, and U.S. Pat. No. 5,679,483, all of which are hereby incorporated by reference herein.

An implantation process may form implanted structures 60 by altering the index of refraction of at least a portion of template 18. Implanted structures 60 may have a refractive index different from the refractive index of formable material 34. Alternatively, the implantation process may form implanted structures 60 by altering the extinction coefficient of at least a portion of template 18.

Implantation processing parameters generally include ion acceleration voltage, deposition flux, implantation dose, time and temperature of post-implantation annealing, and the like. Adjustment of these parameters may provide a distribution of implanted material within template 18. Specifically, adjustment of these parameters may provide a distribution of implanted material within template 18 providing a suitable change in optical properties of template 18 to form an implanted structure 60 as illustrated in FIG. 4. Implanted structures 60 may be visible during contact of template 18 to formable material 34.

Changes in optical properties of template 18 to form visible implanted structures 60 may be achieved by selection of a suitable implantation material. Generally, selection of the implantation material provides for a maximum change in refractive index of at least a portion of template 18 with a minimal dose of implantation material and minimal damage to template 18. Additionally, material selection may provide for implanted structures 60 to be robust during standard processing conditions (e.g., repeated imprinting, repeated exposure to heated oxidizing solutions).

Metallic elements may be used as implantation material. Exemplary metallic elements may include, but are not limited to, tantalum, tungsten, molybdenum, niobium, rhenium, titanium, hafnium, magnesium, aluminum, and/or the like. Generally, metallic elements used for the implantation material are capable of forming stable compounds with silicon and oxygen. Additionally, metallic elements used for the implantation material may have high refractive indices and are generally stable in oxidizing chemistries. FIG. 5 illustrates a graphical representation of several exemplary metallic elements suitable for use as the implantation material. It should be noted, implantation materials are not limited to those illustrated in FIG. 5 but may include others defined by the bounds of the present invention.

Implantation materials may be deposited as metallic impurities within template 18 to form implanted structure 60. Alternatively, implantation materials may be chemically reacted with material of template 18 to form a compound and provide implanted structure 60. Additionally, implantation materials may be co-implanted with another species including, but not limited to, oxygen, nitrogen, silicon, argon and/or the like. Implantation with another species (e.g., oxygen) may further influence physical and/or optical properties of template 18 and/or implanted structures 60. For example, co-implantation of a metallic element with oxygen may form a stable metal oxide implanted structure 60 within template 18.

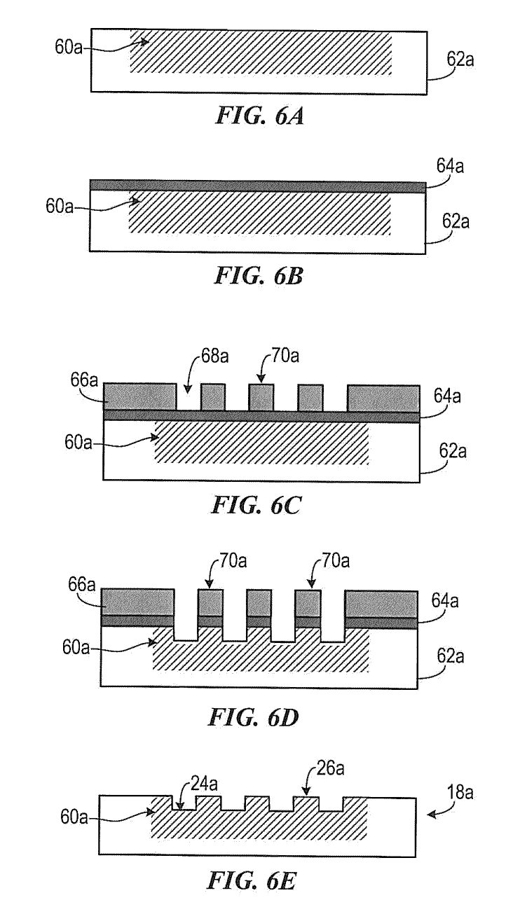

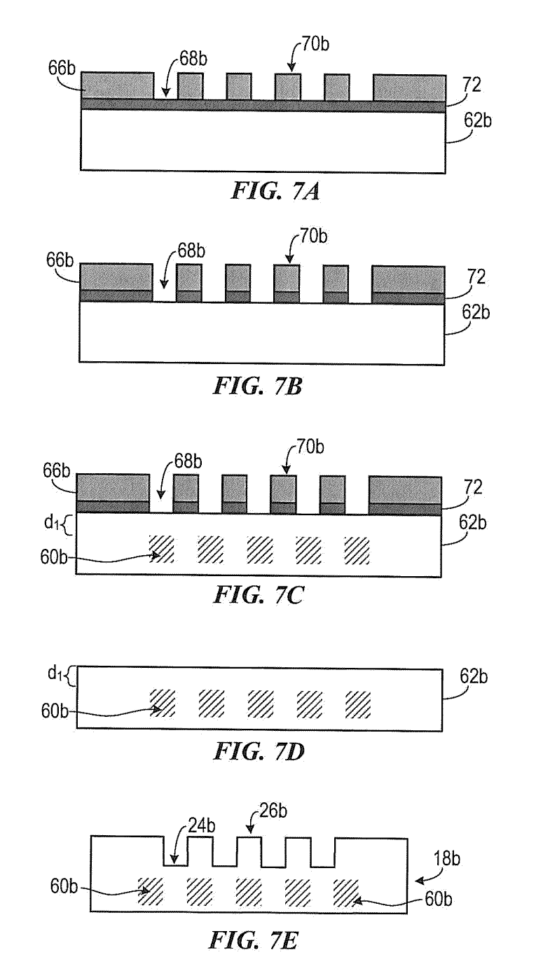

The implantation process may be incorporated during formation of template 18 to provide one or more implanted structures 60 within template 18. FIGS. 6A-6E and FIGS. 7A-7E illustrate exemplary formations wherein implantation may be provided prior to formation of features 24 and 26 of template 18.

Referring to FIGS. 6A-6E, shown therein are simplified side views of exemplary formation of template 18a having implanted structure 60a. Generally, template 18a is formed from substrate 62a. As shown in FIG. 6A, at least a portion of substrate 62a may be implanted such that the implantation process is completed prior to formation of features 24a and/or 26a (shown in FIG. 6E). By completing the implantation process prior to formation of features 24a and/or 26a, implantation-induced damage to template 18a may be mitigated. For example, implantation-induced damage to template 18a may be mitigated by annealing.

Referring to FIG. 6A, substrate 62a may be formed from materials including, but not limited to, quartz, silicon, organic polymers, siloxane polymers, borosilicate glass, fluorocarbon polymers, metal, hardened sapphire, and/or the like.

Hard mask layer 64a may be formed on substrate 62a as illustrated in FIG. 6B. Hard mask layer 64a may be formed from materials including, but not limited to, tantalum, tantalum nitride, tungsten, silicon carbide, amorphous silicon, chromium, chromium nitride, molybdenum, molybdenum silicide, titanium, titanium nitride, and/or the like. Hard mask layer 64a may provide a conductive layer to facilitate electron beam patterning. Additionally, hard mask layer 64a may serve as an etch mask during formation of template 18a.

Resist layer 66a may be formed on hard mask layer 64a as illustrated in FIG. 6C. Resist layer 66a may be formed of materials including, but not limited to, imprint resist material, novolac-type photoresists, acrylate photoresists, epoxy photoresists, bilayer resist materials, and/or the like. Generally, resist layer 66a may be formed of materials having suitably high resistance to ion implantation processing. Resist layer 66a may include one or more recessions 68a and/or protrusions 70a. Recessions 68a and/or protrusions 70a in resist layer 66a may be formed by techniques including, but not limited to, imprint lithography, e-beam lithography, photolithography, x-ray lithography, ion-beam lithography, atomic beam lithography, and/or the like.

Referring to FIG. 6D, the pattern formed by recessions 68a and protrusions 70a in resist layer 66a may be transferred into hard mask layer 64a and/or substrate 62a. For example, the pattern formed by recessions 68 and protrusions 70a may be etched into hard mask layer 64a and substrate 62a. Etching of the hard mask layer 64a may be accomplished with a variety of wet and/or dry etching processes that are well known in the industry.

Referring to FIG. 6E, resist layer 66a and hard mask layer 64a may be subsequently removed forming template 18a having recessions 24a and protrusions 26a and implanted structure 60a wherein at least a portion of recessions 24a and/or protrusions 26a may be formed of implantation material. Implanted structure 60a may be used as alignment marks for alignment processes between template 18a and substrate 12 during the imprinting process described with reference to FIGS. 1 and 2.

FIGS. 7A-7E illustrate simplified side views of exemplary formation of template 18b having implanted structures 60b. Generally, template 18b is formed from substrate 62b shown in FIG. 7A. Substrate 62b may be formed in a similar fashion, and of materials substantially similar to substrate 62a (shown in FIG. 6A).

Protective layer 72 may be formed on substrate 62b. Protective layer 72 may be formed of materials including, but not limited to, chromium, chromium nitride, chromium oxide, gold, palladium, platinum, silver, tantalum, tantalum nitride, tungsten, molybdenum, molybdenum silicide, titanium, titanium nitride, and/or the like.

Resist layer 66b may be formed on protective layer 72 and may include one or more recessions 68b and/or protrusions 70b. Resist layer 66b may be formed in a similar fashion, and of material substantially similar to substrate 66a (shown in FIG. 6C). For example, recessions 68b and/or protrusions 70b in resist layer 66b may be formed by techniques including, but not limited to, imprint lithography, e-beam lithography, photolithography, x-ray lithography, ion-beam lithography, atomic beam lithography and/or the like.

The pattern formed by recessions 68b and protrusions 70b in resist layer 66b may be transferred into protective layer 72 as illustrated in FIG. 7B. For example, the pattern formed by recessions 68b and protrusions 70b may be etched into protective layer 72. Etching of protective layer 72 may be accomplished with a variety of wet and/or dry etching processes that are well known in the industry. The transfer of the pattern into protective layer 72 generally forms a robust implantation mask.

Referring to FIG. 7C, an implantation process may be used to deposit implantation material at a depth d₁ in substrate 62b to form one or more implanted structures 60b. For example, implantation may provide implant material at a depth d₁ in the range of approximately 0 to 5 micrometers. Implanted structure 60b may be formed in superimposition with protrusions 70b, in superimposition with recessions 68b, or a combination thereof. For example, in FIG. 7C, implanted structure 60b is formed in superimposition with recessions 68b. Spacing and distribution of implanted structures 60b may be based on design considerations and/or alignment processes. For example, spacing and distribution may be based on placement of corresponding marks of substrate 12 during the imprinting process described in relation to FIGS. 1 and 2.

Referring to FIGS. 7C-7D, resist 66b and/or protective layer 72 may be removed and substrate 62b may be optionally treated to mitigate implantation-induced damage. For example, substrate 62b may be treated with an annealing step to mitigate implantation-induced damage. Substrate 62b having a plurality of implant structures 60b may be patterned using a process similar to the process shown in FIGS. 6B-6E to form template 18b having recessions 24b and protrusions 26b and implanted structure 60b illustrated in FIG. 7E.

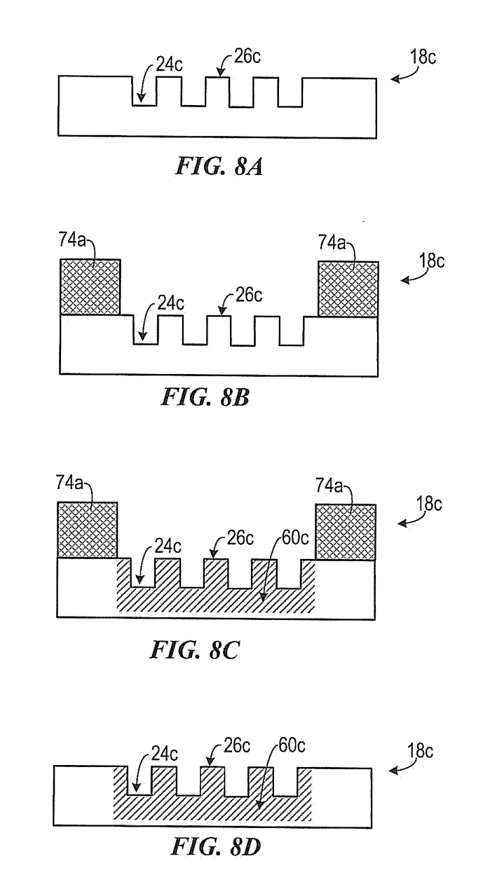

FIGS. 8A-8D, FIGS. 9A-9E and FIGS. 10A-10F illustrate exemplary formations wherein implantation to form implanted structures 60 may be subsequent to formation of features 24c and 26c of template 18c. Generally, each formation begins with features 24c and 26c formed in template 18c as illustrated in FIGS. 8A, 9A and 10A. Features 24c and/or 26c of template 18c may be formed by techniques including, but not limited to imprint lithography, e-beam lithography, photolithography, x-ray lithography, ion-beam lithography, atomic beam lithography, and/or the like.

FIGS. 8A-8D illustrate simplified side views of an exemplary formation of implanted structured 60c in template 18c. Generally, use of resist 74a may provide protection to a portion of template 18c during implantation. For example, positioning of resist 74a may be such that alignment patterns on template 18c may contain implanted structure 60c, while the remainder of template 18c remains unchanged. It should be noted that resist 74a may protect features 24c and 26c and/or portions adjacent to features 24c and 26c.

FIG. 8A illustrates template 18c having features 24c and 26c. Resist 74a may be positioned on at least a portion of template 18c as shown in FIG. 8B (e.g., adjacent to features 24c and 26c). Resist 74a may be formed of material including, but not limited to, imprint resist material, novolac-type photoresists, acrylate photoresists, epoxy photoresists, bilayer resist materials, and/or other similar materials. Generally, resist 74a may be formed of material having a suitably high resistant to ion implantation processing.

Resist 74a may be formed and positioned such that portions of template 18c may be implanted to form one or more implanted structures 60c as shown in FIG. 8C, while remaining portions of template 18 remain unchanged. After implantation, resist 74a may be removed forming template 18c having implanted structure 60c as illustrated in FIG. 8D. Template 18c may optionally be treated to mitigate implantation-induced damage. For example, template 18c may be treated with an annealing step.

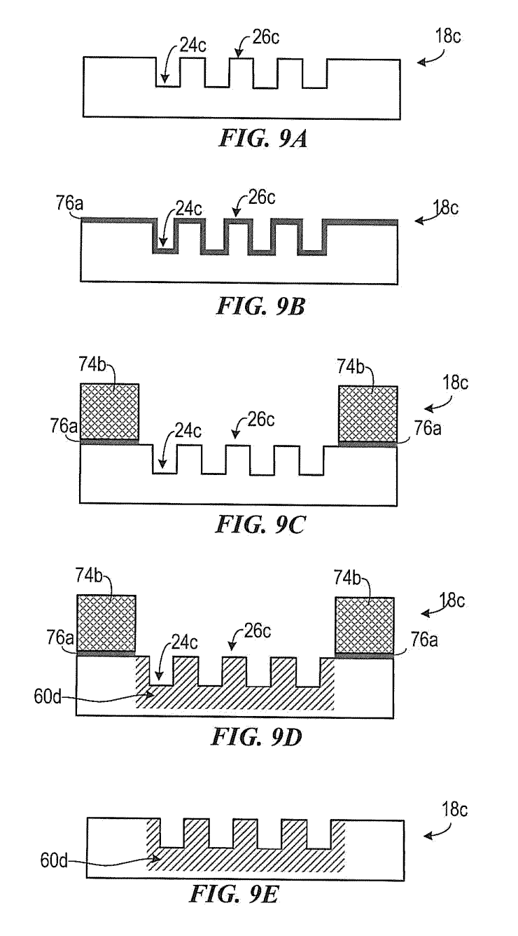

FIGS. 9A-9E illustrate simplified side views of an exemplary formation of implanted structure 60d in template 18c. Generally, use of resist 74b may provide protection to a portion of template 18c as the implantation process occurs similar to the formation illustrated in FIGS. 8A-8D. For example, positioning of resist 74b may be such that patterns on template 18c may contain implanted structure 60d, while the remainder of template 18c remains unchanged. In addition, protective layer 76a may be provided to further mask the implantation process.

As shown in FIG. 9B, protective layer 76a may be formed on template 18c. Protective layer 76a may be formed of materials including, but not limited to chromium, chromium nitride, chromium oxide, gold, palladium, platinum, silver, tantalum, tantalum nitride, tungsten, molybdenum, molybdenum silicide, titanium, titanium nitride, and/or the like.

Protective layer 76a may be formed using techniques including, but not limited to, imprint lithography, e-beam lithography, photolithography, x-ray lithography, ion-beam lithography, atomic beam lithography, and/or the like. Alternatively, protective layer 76a may be deposited on features 24c and/or 26c. For example, a continuous coating of protective layer 76a may be deposited on features 24c and/or 26c. In another embodiment, a distributive coating of protective layer 76a may be deposited on features 24c and/or 26c.

Resist 74b may be positioned on protective layer 76a as illustrated in FIG. 9C. Resist 74b and protective layer 76a may mask portions of template 18c during the formation of implanted structure 60d shown in FIG. 9D. After implantation, resist 74b may be removed forming template 18c having implanted structure 60d as illustrated in FIG. 9E. Template 18c may optionally be treated to mitigate implantation-induced damage. For example, template 18c may be treated with an annealing step.

Formation of implanted structures 60c and/or 60d in FIGS. 8D and 9E may provide a mechanism to define alignment patterns and high resolution active area patterns on the template 18 in a single lithography step. This type of patterning may facilitate accurate registration between the patterns. Additionally, fine alignment may not be necessary between the pattern of template 18 and the implantation process.

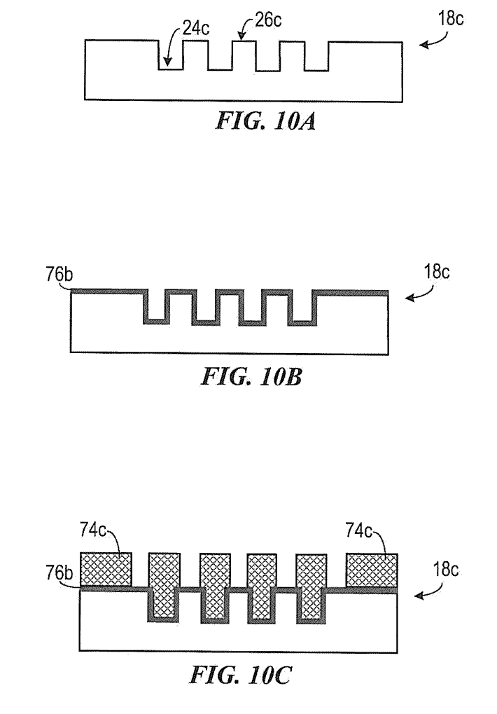

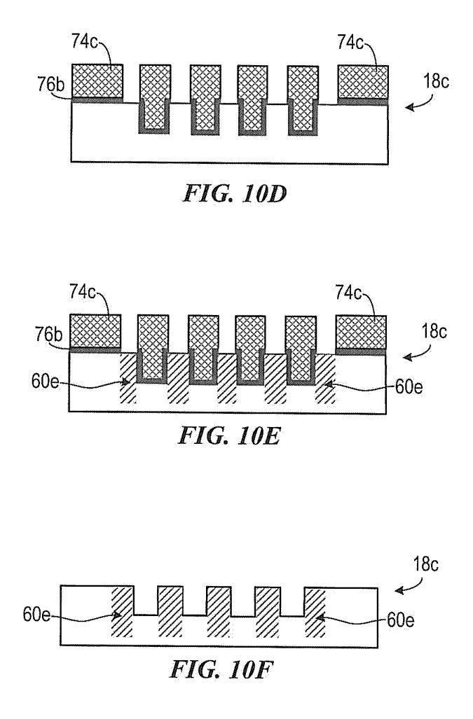

FIGS. 10A-10F illustrate simplified side views of an exemplary formation of implanted structures 60e in template 18c. Generally, use of resist 74c and protective layer 76b may provide protection to a portion of template 18c as the implantation process occurs similar to the formation illustrated in FIGS. 9A-9E. Positioning of resist 74b may be such that multiple implanted structures 60e are formed in template 18c. In particular, at least a portion of protrusions 26c of template 18c may include implanted material.

Protective layer 76b may be formed on template 18c as illustrated in FIG. 10B. Protective layer 76b may be formed similar to and of substantially similar materials to protective layer 76a described herein.

One or more resists 74c may be positioned on protective layer 76b as shown in FIG. 10C. For example, resists 74c may be positioned in superimposition with protrusions 26c, in superimposition with recessions 24c, or a combination thereof. The pattern formed by resist 74c may be transferred into protective layer 76b shown in FIG. 10D. For example, the pattern formed by resists 74c may be etched into protective layer 76b. Resists 74c and protective layer 76b may provide a protective mask for portions of template 18c during implantation.

Referring to FIG. 10E, the implantation process may provide implanted structures 60e in one or more unmasked portions of template 18c (e.g., protrusions 26c). Following implantation, resists 74c and protective layer 76b may be removed from template 18c as shown in FIG. 10F to form template 18c having implanted structures 60e.

Implantation structures 60 provide one example of buried alignment marks as described herein. Buried alignment marks may be used in conjunction with complimentary alignment marks to align template 18 and substrate 12 during imprinting as described in relation to FIGS. 1 and 2.

In imprint lithography processes as described in relation to FIGS. 1 and 2, alignment marks may be formed as topographical features of patterned surface 22 of template 18. Alignment marks are made of the same material as template 18. Formable material 34 may have a refractive index that is substantially similar to the refractive index of material forming template 18 and topographical alignment marks. Therefore, when formable material 34 fills the gap between template 18 and substrate 12, topographical alignment marks become substantially transparent and difficult to recognize.

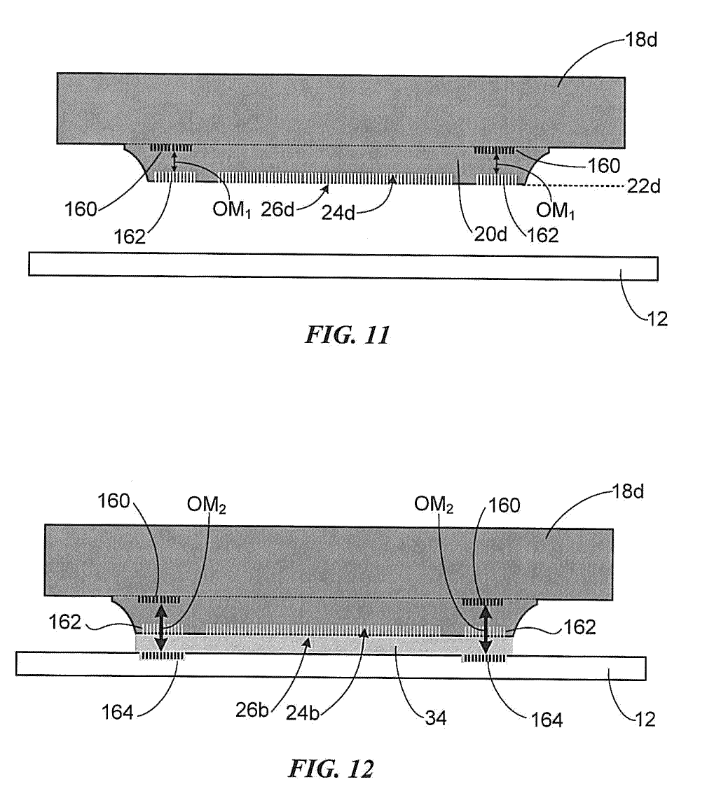

FIG. 11 illustrates one embodiment of an alignment system using a set of alignment marks (e.g., buried alignment mark 160 and complementary alignment mark 162) formed in template 18d and/or substrate 12 that provide visible contrast and alignment measurements prior to and/or subsequent to deposition of formable material 34. In particular, buried alignment marks 160 may be formed of a material different than template 18d and complementary alignment marks 162 may be formed of material similar to template 18d. For example, a material selected to form template 18d and complementary alignment marks 162 may be substantially non-visible at a wavelength (e.g., transparent) during contact of template 18d with formable material 34 in alignment of template 18d and substrate 12. A material selected to form buried alignment marks 160 may be substantially different from the material forming template 18d and/or complementary alignment marks 162 and visible at the same wavelength (e.g., opaque) during contact of template 18d with formable material 34.

Buried alignment marks 160 and complementary alignment marks 162 may be of many configurations and/or arrangements. For example, buried alignment marks 160 and/or complementary alignment marks 162 may be circular, rectangular, square, polygonal, or any fanciful shape.

Buried alignment marks 160 may be positioned a distance d within template 18d. For example, buried alignment marks 160 in FIG. 5 may be positioned within template 18 a distance d such that buried alignment mark 160 may be embedded within template 18d. General depth of alignment marks 160 may be dependent on design considerations (e.g., fabrication method), and may vary from approximately 100 nm to 30 um.

Buried alignment marks 160 may be formed from materials that provide visibility (e.g., opaque) during the alignment process (e.g., when template 18d is in contact with formable material 34). In one example, buried alignment marks 160 may be formed from materials having a substantially different index of refraction than formable material 34. Materials forming buried alignment marks 160 may include, but are not limited to, tantalum, tantalum nitride, tungsten, silicon carbide, amorphous silicon, chromium, chromium nitride, molybdenum, molybdenum silicide, titanium, titanium nitride, and/or the like. Buried alignment marks 160 may be visible to wavelengths ranging from 350 nm to 700 nm typically used by an optical imaging system for alignment and/or to wavelengths of energy 40 used during the imprint lithography process as described in relation to FIGS. 1 and 2.

In one embodiment, complementary alignment marks 162 may be positioned in superimposition with buried alignment marks 160. For example, buried alignment marks 160 may be positioned at a distance d within template 18 and in superimposition with complementary alignment marks patterned on surface 22d of template 18. Buried alignment marks 160 may be substantially in superimposition with complementary alignment marks 162, have only a portion in superimposition with complementary alignment marks 162, or be removed from complementary alignment marks 162.

Complementary alignment marks 162 may be formed adjacent to features (e.g., recesses 24d and protrusions 26d) within patterned surface 22d. Complementary alignment marks 162 may be formed in substantially the same patterning step of formation of features within patterned surface 22d. By forming both complementary alignment marks 162 and features within patterned surface 22d in substantially the same patterning step, complementary alignment marks 162 may provide a reference of overlay errors between buried alignment marks 160 and features within patterned surface 22d as described in further detail herein.

Complementary alignment marks 162 may be formed in traditional scribe areas designated for measurement and alignment, but outside of area of features 24 and 26 of patterned surface 22d. For example, complementary alignment marks 162 may be formed such that 60 um width mark may reside in typical horizontal and vertical semiconductor scribe lanes, and no trench exists between complementary alignment marks 162 and features within patterned surface 22d. Complementary alignment marks 162 and/or features may be formulated having a substantially similar index of refraction as formable material 34. Indices of refraction with less than 0.2 difference may have significant loss of optical contrast. Complementary alignment marks 162 and/or features may lose visible contrast when the formable material 34 is adjacent to complementary alignment mark 162. As such, visibility of complementary alignment mark 162 and/or features may be controlled. For example, complementary alignment marks 162 may be non-visible to wavelengths used by an optical imaging system for alignment when in contact with formable material 34 and/or to non-visible (e.g., translucent) to wavelengths of energy 40 used during the imprint lithography process as described in relation to FIGS. 1 and 2.

As illustrated in FIGS. 11 and 12, complementary alignment marks 162, in combination with the buried alignment marks 160, may be used to align template 18d and substrate 12. In one embodiment, complementary alignment marks 162 may be: (1) visible during a first overlay measurement OM₁ between complementary alignment marks 162 and buried alignment marks 160; and, (2) substantially non-visible during a second overlay measurement OM₂ between buried alignment marks 160 and substrate alignment marks 164. Both overlay measurements OM₁ and OM₂ may be used in aligning template 18d and substrate 12 during imprinting using system 10 and methods described in relation to FIGS. 1 and 2.

As described, complementary alignment marks 162 may be visible in the absence of formable material 34. If complementary alignment marks 162 are visible, a first overlay measurement OM₁ may be determined between complementary alignment marks 162 (on patterned surface 22d of template 18) and buried alignment marks 160 as illustrated in FIG. 11.

First overlay measurement OM₁ is generally determined prior to deposition of formable material 34 (e.g., in relation to FIGS. 1 and 2). First overlay measurement OM₁ between buried alignment marks 160 and corresponding visible complementary alignment marks 162 on patterning surface 22d may include rigid body errors (e.g., x, y, T positional displacement errors) and/or deformation errors (e.g., scale shape, and/or distortion). Relative differences between buried alignment marks 160 and corresponding visible complementary alignment marks 162 may provide information on overlay error between buried alignment marks 160 and patterning surface 22d, as complementary alignment marks 162 are generally formed during the same step as formation of the features 24d and 26d of patterning surface 22d.

For second overlay measurement OM₂, complementary alignment marks 162 may be substantially non-visible. As described, complementary alignment marks 162 may be formed having substantially the same index of refraction as formable material 34 and, thus, may be substantially non-visible in the presence of formable material 34. Substantial non-visibility of complementary alignment marks 162 may provide a substantially unobstructed view between buried alignment marks 160 and corresponding alignment marks of substrate 12 when template 18 is in contact with formable material 34. If complementary alignment marks 162 are substantially non-visible, a second overlay measurement OM₂ may be determined between buried alignment marks 160 and substrate 12. As such, second overlay measurement OM₂ is generally determined subsequent to deposition of formable material 34.

Referring to FIGS. 1, 2, 11 and 12, first overlay measurement OM₁ and second overlay measurement OM₂ may be used to align template 18d and substrate 12. For example, first overlay measurement OM₁ (between buried alignment marks 160 and complementary alignment marks 162) may provide overlay errors between buried alignment marks 160 and feature area (e.g., recessions 24 and protrusions 26). Second overlay measurement OM₂ may provide overlay errors between buried alignment marks 160 and surface of substrate 12 without obstruction by complementary alignment marks 162. The offsets from first overlay measurement OM₁ may be applied to an alignment algorithm so that alignment with buried alignment marks 160 may be provided with minimum overlay error between feature area of patterning surface 22 and corresponding pattern on substrate 12. As such, incorporating offsets from first overlay measurement OM₁ into second overlay measurement OM₂ may provide minimum overlay error between patterning surface 22d of template 18d and corresponding features 50 and 52 on substrate 12. Such a technique may be incorporated into alignment methods, including, but not limited to those described in detail in U.S. patent application Ser. No. 11/694,644, U.S. Pat. No. 7,136,150, U.S. Pat. No. 6,916,584, and U.S. Pat. No. 7,070,405, all of which are hereby incorporated by reference. Additionally, as one skilled in the art will recognize, offsets from first overlay measurement OM₁ into second overlay measurement OM₂ may be incorporated into any alignment technique used within the industry.

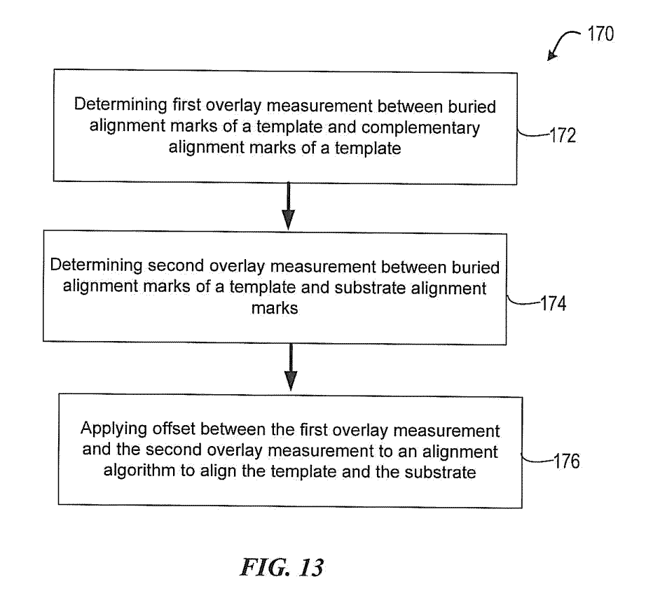

FIG. 13 illustrates a flow chart 170 of an exemplary method for minimizing overlay error during alignment of template 18 and substrate 12. In a step 172, first overlay measurement OM₁ may be determined between buried alignment marks 160 and complementary alignment marks 162. In a step 174, second overlay measurement OM₂ may be determined between buried alignment marks 160 and substrate alignment marks 164. First overlay measurement OM₁ may correspond to second overlay measurement OM₂. In a step 176, offset provided by first overlay measurement OM₁ may be incorporated into an alignment algorithm for second overlay measurement OM₂ to provide alignment between buried alignment marks 160 and substrate alignment marks 164 having minimum overlay error between template 18 and substrate 12. Multiple alignment sites within the patterning surface may be measured substantially simultaneously as illustrated in flow chart 170 as input into the alignment algorithms for minimum overlay error.

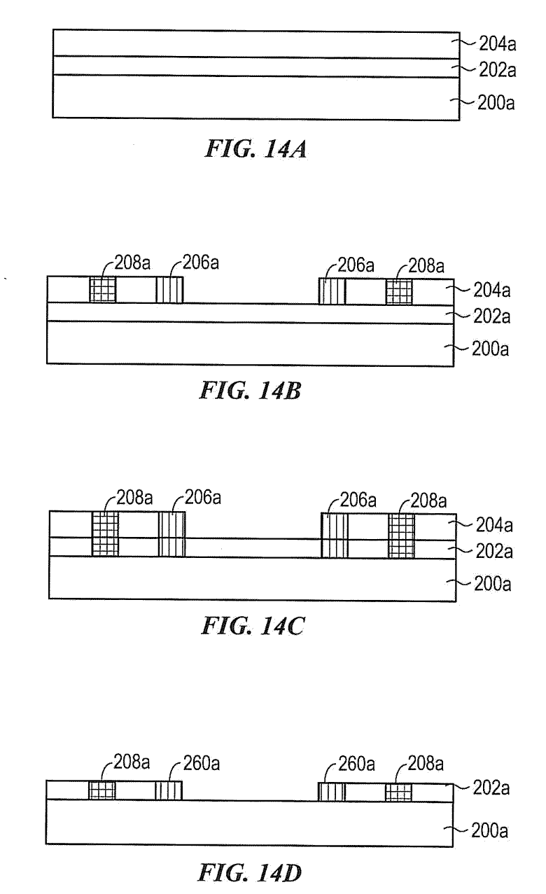

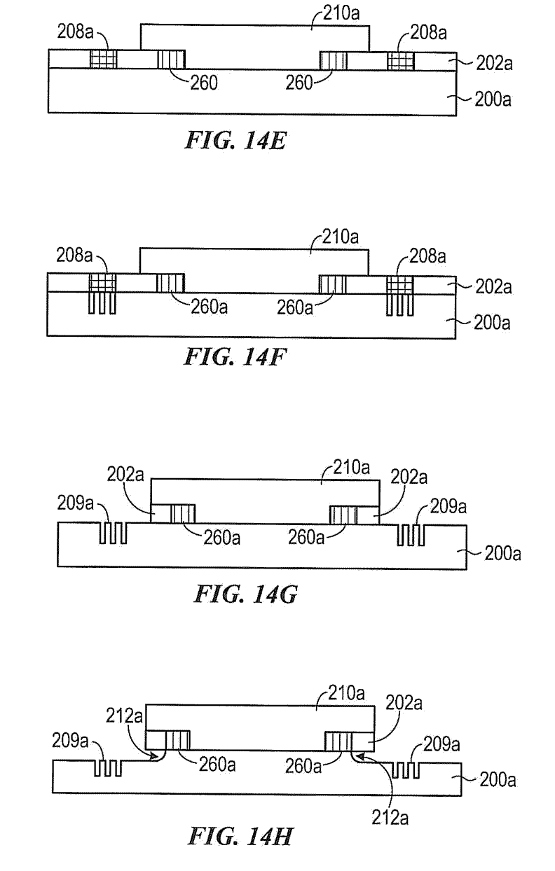

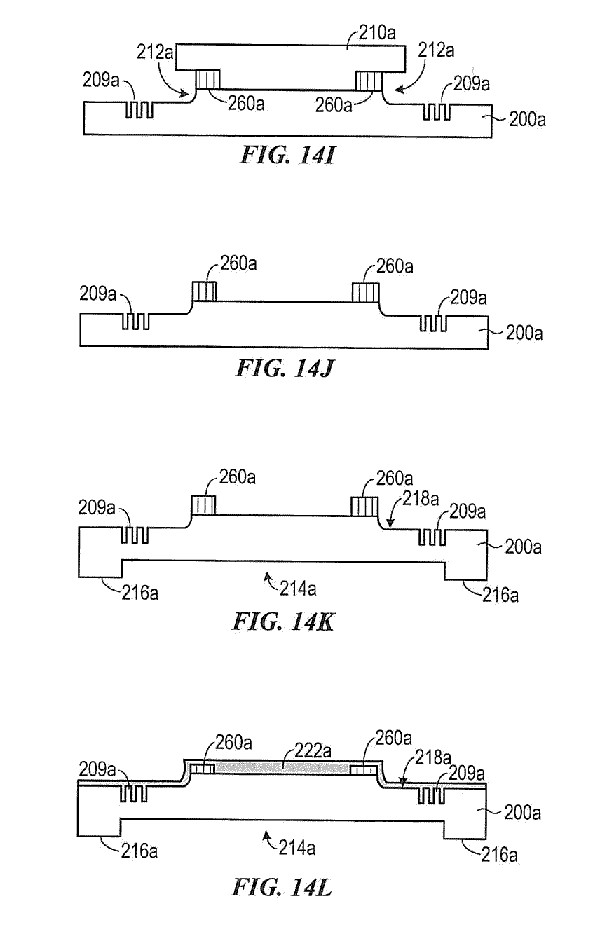

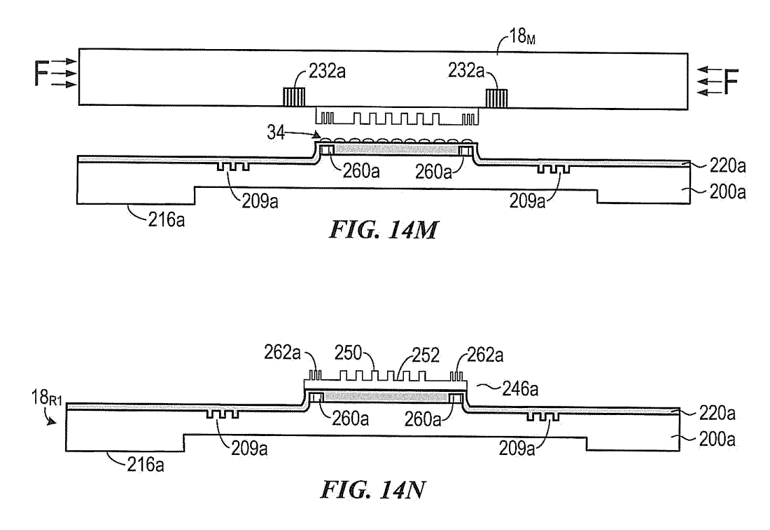

FIGS. 14-16 illustrate exemplary methods for forming templates 18 having buried alignment marks 260a-c and complementary alignment marks 262a-c for use in the processes describe herein. In particular, such figures illustrate the formation of replica templates 18_{R} from a master template 18_{M}.

Master templates 18_{M} are generally formed by time consuming and expensive processes such as, for example, e-beam lithography. Replica templates 18_{R} provide an alternate low-cost means of forming templates 18 for use in processes and system 10 described herein.

FIGS. 14A-N illustrate an exemplary method for forming replica template 18_{R1} having buried alignment marks 260a and complementary alignment marks 262a. Buried alignment marks 260b and complimentary alignment marks 262b may be used in accordance with the system and methods described in relation to buried alignment marks 160 and complimentary alignment marks 162.

Referring to FIG. 14A, substrate 200a may be provided having a metal layer 202a formed thereon (e.g., sputtering). Substrate 200a may be formed from such materials including, but not limited to, fused-silica, quartz, silicon, organic polymers, siloxane polymers, borosilicate glass, fluorocarbon polymers, metal, hardened sapphire, and/or the like. Metal layer 202a may be formed from such materials including, but not limited to, tantalum, tantalum nitride, tungsten, silicon carbide, amorphous silicon, chromium, chromium nitride, molybdenum, molybdenum silicide, titanium, titanium nitride, and/or the like.

A first resist layer 204a may be formed on metal layer 202a as illustrated in FIG. 14A. First resist layer 204a may be formed of materials including, but not limited to, imprint resist material, novolac-type photoresists, acrylate photoresists, epoxy photoresists, bilayer resist materials, and/or the like.

Referring to FIG. 14B, alignment features 206a and 208a may be patterned in first resist layer 204a. Alignment features 206a and 208a formed in first resist layer 204a may be precursors to formation of burled alignment marks 260a and substrate reference marks 209a.

Alignment features 206a and 208a may be patterned in first resist layer 204a using techniques including, but not limited to, imprint lithography, e-beam lithography, photolithography, x-ray lithography, ion-beam lithography, atomic beam lithography, and/or the like. For example, alignment features 206a and 208a may be patterned by a first lithography step as described in the systems and processes related to FIGS. 1 and 2.

Referring to FIG. 14C, alignment features 206a and 208a may be etched (e.g., Cr etch) into metal layer 202a. First resist layer 204a may then be removed to form buried alignment marks 260 from alignment features 206a as shown in FIG. 14D.

Referring to FIG. 14E, a second resist layer 210a may be positioned on metal layer 202a. Second resist layer 210a may be positioned over buried alignment marks 260 while exposing alignment features 208a. For example, second resist layer 210a may be patterned over buried alignment marks 260 in a second lithography step. Second resist layer 210a may be formed of materials including, but not limited to, imprint resist material, novolac-type photoresists, acrylate photoresists, epoxy photoresists, bilayer resist materials, and/or the like. Materiality of second resist layer 210a may be substantially similar or substantially different from first resist layer 204a depending on design considerations.

Referring to FIG. 14F, alignment features 208a may be etched (e.g., oxide etch) into substrate layer 200a. Metal layer 202a may then be removed to form substrate alignment marks 209a as shown in FIG. 14G.

Referring to FIG. 14H, portions of substrate layer 200a may be etched (e.g., BOE etch) providing a sloped wall 212a in substrate layer 200a and effectively raising the patterning surface 22 from the non patterning surface of 18 in FIG. 1. Portions of metal layer 202a may then be removed as shown in FIG. 14I. For example, portions of metal layer 202a undercut in step FIG. 14H and unsupported by substrate layer 200a may be removed. Second resist layer 210a may then be removed (e.g., stripped) as shown in FIG. 14J.

Referring to FIG. 14K, a recess 214a may be formed on a first side 216a of substrate layer 200a (e.g., cored out). For example, recess 214a may be formed on first side 216a of substrate layer 200a using techniques and processes described in U.S. Ser. No. 11/744,698, which is herein incorporated in its entirety.

Referring to FIG. 14L, an oxide layer 222a may be positioned on second side 218a of substrate layer 200a. Additionally, a hard mask layer and/or an adhesion layer may be positioned on oxide layer 222a. Exemplary adhesion layers and techniques are further described in U.S. Publication No. 2007/0212494, which is hereby incorporated by reference in its entirety.

Referring to FIGS. 14M and 14N, master template 18_{M} may be used to imprint features (e.g., features 24 and 26) on substrate 200a and provide patterned layer 246a having features 250 and 252 and/or complementary alignment marks 262a.

Substrate 200a may be placed in superimposition with master template 18M as illustrated in FIG. 14M. Substrate alignment marks 236a on master template 18_{M} may be aligned with corresponding substrate reference marks 209a on substrate 200a. One or more forces F may be applied to master template 18_{M} and/or substrate 200a to adjust magnification and other alignment parameters. Formable material 34 may be deposited on substrate 200a and patterned to provide patterned layer 246a as illustrated in FIG. 14O. For example, formable material 34 may be patterned using systems and methods described in relation to FIGS. 1 and 2 to form patterned layer 246a that may include complimentary alignment marks 262a and/or patterned features 250 and 252. Template 18_{M} may be separated from patterned layer 246a forming a relief image of 18_{M} patterned surface on the replica template 18_{R1}. Patterned layer 246a may be formed of materials including, but not limited to, imprint resist material, novolac-type photoresists, acrylate photoresists, epoxy photoresists, bilayer resist materials, and/or the like. Patterned layer 246a may then be further patterned transferred into layer 220a using typical etch processes (e. g., RIE oxide etch) such that the etched layer may be used as patterning surface 22 in FIG. 1. Alternatively, the relief image in FIG. 14N, may be formed of a functional material (e.g., SiOx based material) such that layer 246a may be used as the patterning surface 22 in FIG. 1 without any significant processing. Replica template 18_{R1} includes buried alignment marks 260a and complimentary alignment marks 262a for use in an alignment process as described herein.

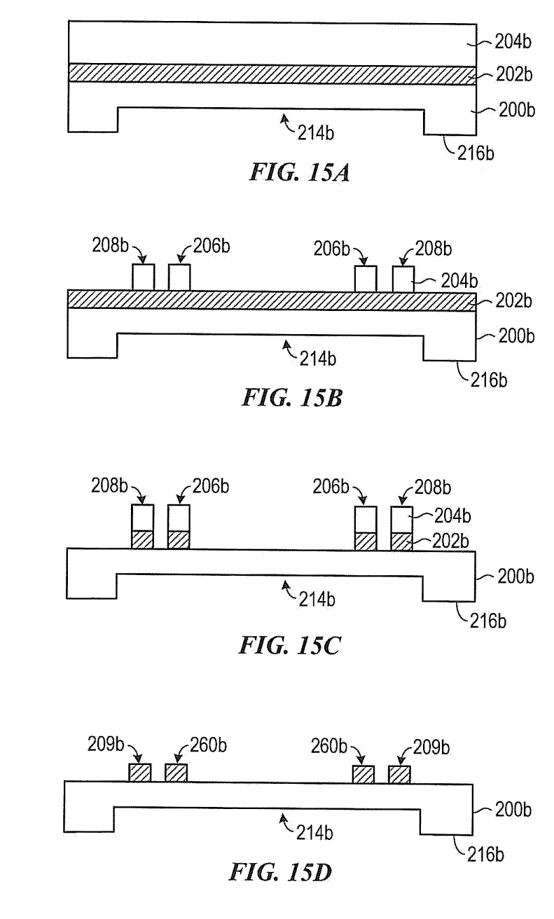

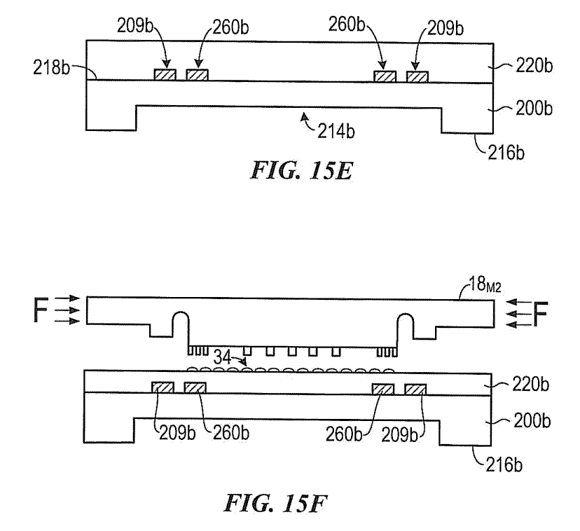

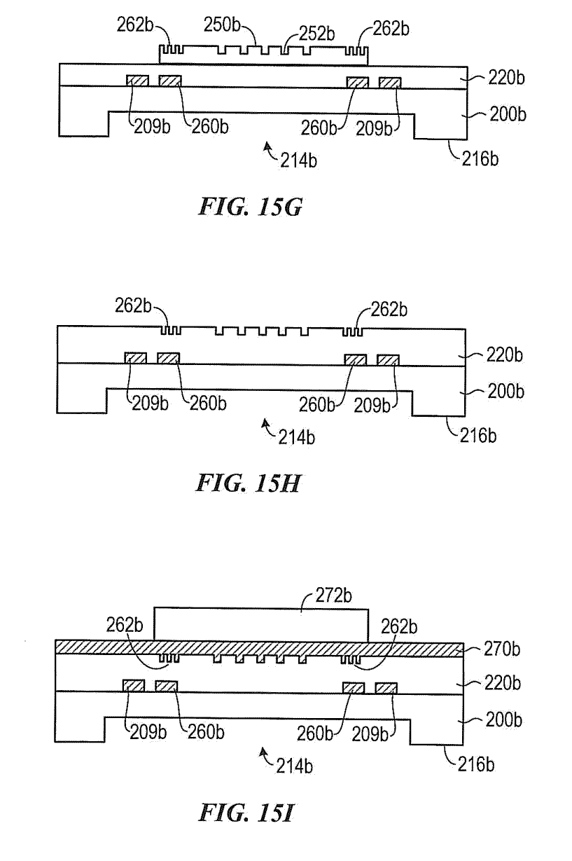

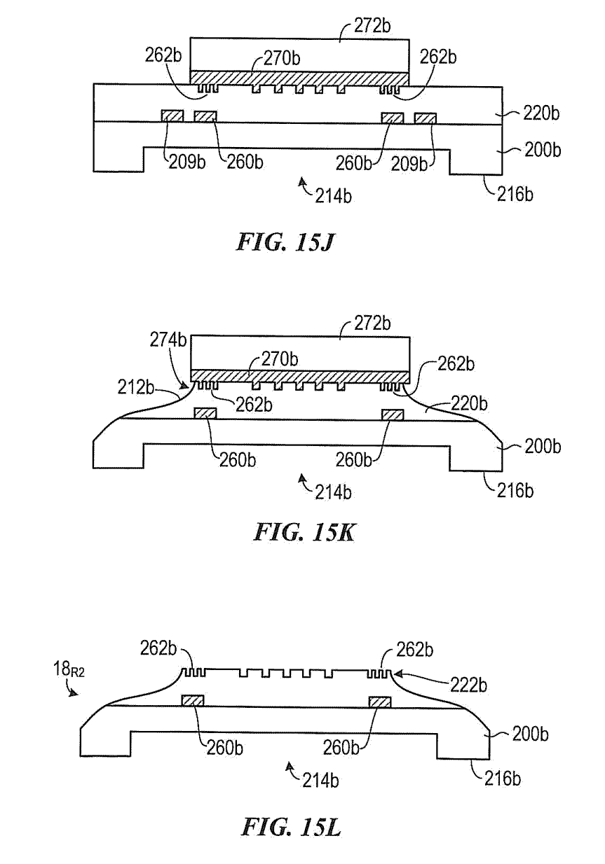

FIGS. 15A-15L illustrates simplified side views of another exemplary method for formation of replica template 18_{R2} buried alignment marks 260b and complementary alignment marks 262b. Buried alignment marks 260b and complimentary alignment marks 262b may be used in accordance with the system and methods described in relation to buried alignment marks 160 and complimentary alignment marks 162.

Referring to FIG. 15A, substrate 200b may be initially provided with recess 214b and/or recess 214b may be initially formed in substrate 200b. Substrate 200b may be formed from materials similar to materials of 200a shown in FIG. 14A. Recess 214b may be formed on a first side 216b of substrate 200b, and may be formed using techniques and processes described in U.S. Ser. No. 11/744,698.

Metal layer 202b may be deposited on substrate 200b. Metal layer 202b may be formed of materials similar to materials of 202a shown in FIG. 14A. A first resist layer 204b may be formed on metal layer 202b as illustrated in FIG. 15A. First resist layer 204b may be formed of materials similar to materials of resist layer 204a shown in FIG. 14A.

Referring to FIG. 15B, alignment features 206b and 208b may be patterned in first resist layer 204b. Alignment features 206b and 208b formed in first resist layer 204b may be precursors to formation of buried alignment marks 260b and substrate reference marks 209b.

Alignment features 206b and/or 208b may be patterned in first resist layer 204b using techniques including, but not limited to, imprint lithography, e-beam lithography, photolithography, x-ray lithography, ion-beam lithography, atomic beam lithography, and/or the like. For example, alignment features 206b and/or 208b may be patterned by a first lithography step as described in relation to the systems and processes of FIGS. 1 and 2.

Referring to FIG. 15C, metal layer 202b may be etched (e.g., Cr etch) such that portions of metal layer 202b may be removed from substrate 200b. First resist layer 204b may then be removed from alignment features 206b and 208b to form buried alignment marks 260b and substrate reference marks 209a as illustrated in FIG. 15D.

Referring to FIG. 15E, an oxide layer 220b may be positioned on second side 218b of substrate layer 200a. Additionally, a hard mask layer and/or an adhesion layer may be positioned on oxide layer 220b. Exemplary adhesion layers and techniques are further described in U.S. Publication No. 2007/0212494, which is hereby incorporated by reference in its entirety.

Referring to FIGS. 15F and 15G, master template 18_{M2} may be used to imprint features (e.g., features 24 and 26) on substrate 200b and provide patterned layer 246b having features 250b and 252b and/or complementary alignment marks 262b.

Substrate 200b may be placed in superimposition with master template 18_{M2} as illustrated in FIG. 15F. Substrate alignment marks 236b of master template 18_{M2} may be aligned with corresponding substrate reference marks 209b on substrate 200b. For example, one or more forces F may be applied to master template 18_{M2} and/or substrate 200b to align substrate reference marks 209a with substrate alignment marks 236b.

Formable material 34 may be deposited on substrate 200b and patterned to provide patterned layer 246b as illustrated in FIG. 15G. For example, formable material 34 may be patterned using systems and methods as described in relation to FIGS. 1 and 2. Patterned layer 246b may include complementary alignment marks 262b and/or patterned features 250 and 252. Substrate 200b having patterned layer 246b positioned thereon may be subjected to further processing to transfer the pattern into oxide layer 220b (FIG. 15H) and form a pedestal (FIGS. 15I-15L).

Referring to FIG. 15H, pattern of features 250 and 252 and complementary alignment marks 262b may be transferred into oxide layer 220b. Transfer of pattern may include, but is not limited to, process as described in U.S. Ser. No. 10/396,615, U.S. Ser. No. 11/127,041, U.S. Ser. No. 10/946,565, U.S. Ser. No. 10/946,159, U.S. Ser. No. 11/184,664, and U.S. Ser. No. 11/611,287, all of which are hereby incorporated by reference in their entirety.

Referring to FIG. 15I, a second metal layer 270b may be deposited on oxide layer 220b. Second metal layer 270b may be formed of materials similar to those materials disclosed in relation to first metal layer 202b shown in FIG. 15A. A second resist layer 272b may be deposited on a portion of second metal layer 270b. Second resist layer 272b may be positioned in superimposition with pattern features 250b and 252b and/or complementary alignment marks 262b as illustrated in FIG. 15I. Second resist layer 272b may be formed of materials similar to those materials disclosed in relation to first resist layer 204b.

Referring to FIG. 15J, portions of second metal layer 270b not in contact with second resist layer 272b may be etched (e.g., Cr etch). Portions of oxide layer 220b and substrate 200b may be etched to provide sloped walls 212b forming pedestal 274b as illustrated in FIG. 15K. Subsequent to formation of pedestal 274b, second resist layer 272b and second metal layer 270b may be stripped forming replica template 18_{R2} shown in FIG. 15L. Replica template 18_{R2} includes buried alignment marks 260b and complimentary alignment marks 262b for use in an alignment process as described herein.

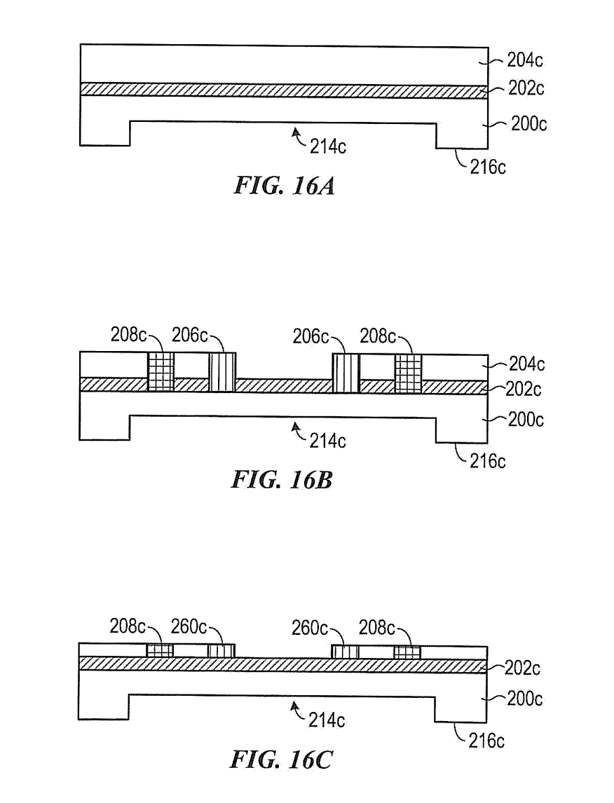

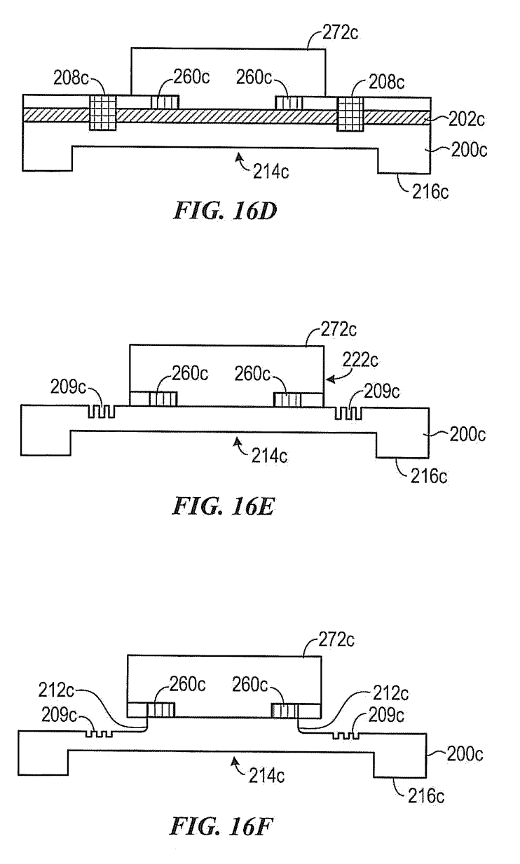

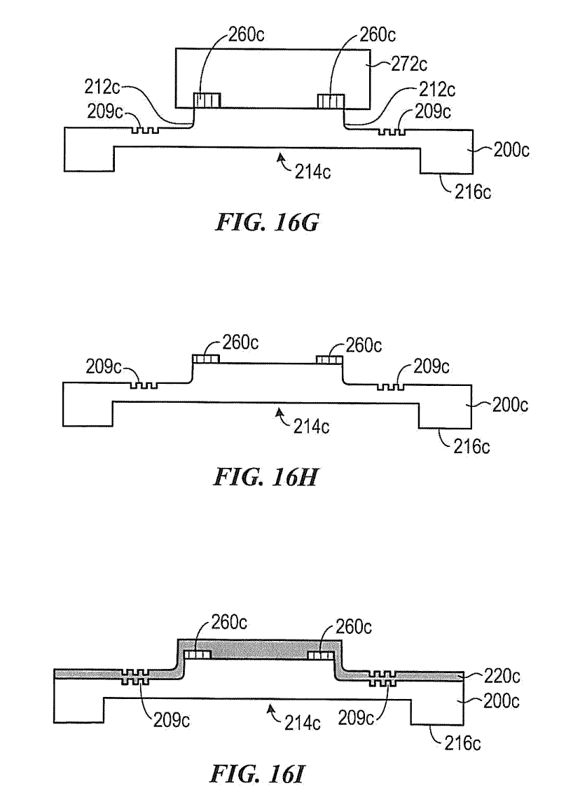

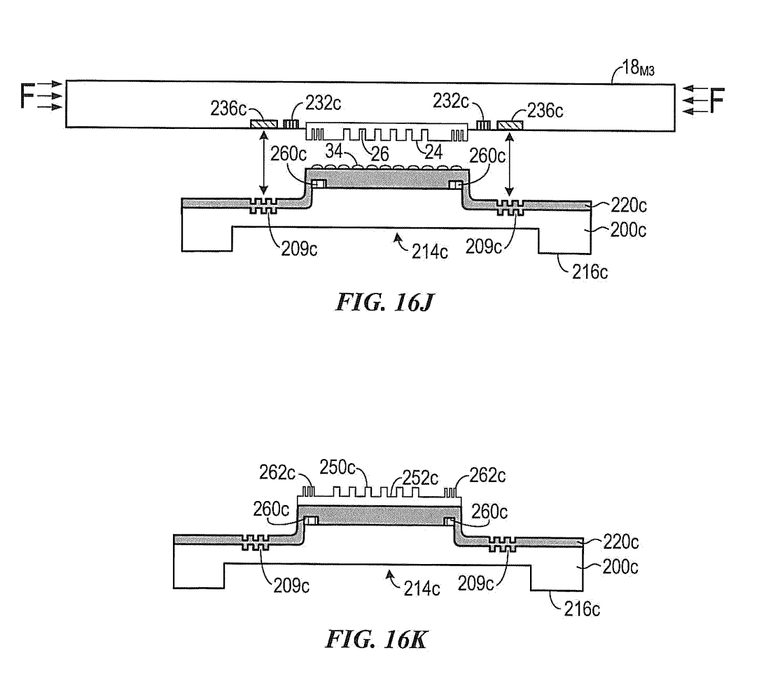

FIGS. 16A-16K illustrate simplified side views of another exemplary method for formation of replica template 18_{R3} having buried alignment marks 260c and complementary alignment marks 262c. Buried alignment marks 260c and complimentary alignment marks 262c may be used in accordance with the system and methods described in relation to buried alignment marks 160 and complimentary alignment marks 162.

Referring to FIG. 16A, substrate 200c may be initially provided with recess 214c and/or recess 214c may be initially formed in substrate 200b. Substrate 200c may be formed from materials similar to materials of 200a shown in FIG. 14A. Recess 214c may be formed on a first side 216c of substrate 200c. For example, recess 214c may be formed using techniques and processes described in U.S. Ser. No. 11/744,698.

Metal layer 202c may be deposited on substrate 200c. Metal layer 202c may be formed of materials similar to materials of 202a shown in FIG. 14A. A first resist layer 204c may be formed on metal layer 202c as illustrated in FIG. 16A. First resist layer 204c may be formed of materials similar to materials of resist layer 204a shown in FIG. 14A.

Referring to FIG. 16B, alignment features 206c and 208c may be patterned in first resist layer 204c. Alignment features 206c and 208c formed in first resist layer 204c may be precursors to formation of buried alignment marks 260e and substrate reference marks 209c.

Alignment features 206c and/or 208c may be patterned in first resist layer 204c using techniques including, but not limited to, imprint lithography, e-beam lithography, photolithography, x-ray lithography, ion-beam lithography, atomic beam lithography, and/or the like. For example, alignment features 206c and/or 208c may be patterned by a first lithography step as described in relation to the systems and processes of FIGS. 1 and 2.

Referring to FIGS. 16B and 16C, alignment features 206c and 208c may be etched (e.g., Cr etch) into metal layer 202a and portions of first resist layer 204c removed to form buried alignment marks 260a from alignment features 206a. A second resist layer 272c may be positioned on metal layer 202c as illustrated in FIG. 16D. Second resist layer 272c may be positioned over buried alignment marks 260c while exposing alignment features 208a. Second resist layer 272c may be formed of materials including, but not limited to, imprint resist material, novolac-type photoresists, acrylate photoresists, epoxy photoresists, bilayer resist materials, and/or the like. Materiality of second resist layer 272c may be substantially similar or substantially different from first resist layer 204c depending on design considerations.

Referring to FIGS. 16D-16E, alignment features 208c may be etched (e.g., oxide etch) into substrate layer 200c. Metal layer 202c may be removed to form substrate alignment marks 209a as shown in FIG. 14E.

Referring to FIG. 16F, portions of substrate layer 200c may be etched (e.g., BOE etch) providing a sloped wall 212c in substrate layer 200c. Portions of metal layer 202c may then be removed as shown in FIG. 16G. For example, portions of metal layer 202c unsupported by substrate layer 200c may be removed. Second resist layer 272c may then be removed (e.g., stripped) as shown in FIG. 16H.

Referring to FIG. 16I, an oxide layer 220c may be positioned on second side 218c of substrate layer 200c. Additionally, a hard mask layer and/or an adhesion layer may be positioned on oxide layer 220c. Exemplary adhesion layers and techniques are further described in U.S. Publication No. 2007/0212494, which is hereby incorporated by reference in its entirety.

Referring to FIGS. 16J-K, master template 18_{M3} may be used to imprint features (e.g., features 24 and 26) on substrate 200c and provide patterned layer 246c having features 250c and 252c and/or complementary alignment marks 262c.

Referring to FIG. 16J, substrate 200c may be placed in superimposition with master template 18_{M3}. Substrate alignment marks 236c on master template 18_{M3} may be aligned with corresponding substrate reference marks 209c on substrate 200c. For example, one or more forces F may be applied to master template 18_{M3} and/or substrate 200c to align substrate reference marks 209c with substrate align marks 236c.

Formable material 34 may be deposited on substrate 200c and patterned to provide patterned layer 246c as illustrated in FIG. 16K. For example, formable material 34 may be patterned using systems and methods described in relation to FIGS. 1 and 2. Patterned layer 246c may include complimentary alignment marks 262c and/or patterned features 250c and 252c. Template 18_{M3} may be separated from patterned layer 246c to provide replica template 18_{R3} having buried alignment marks 260c and complimentary alignment marks 262c for use in an alignment process as described herein.

What is claimed is:

1. An imprint lithography template for patterning formable material positioned on a substrate, comprising:
a body having a first side and a second side;
a mold having a patterned surface, the mold positioned on the first side of the body, the patterned surface having a feature area defining a first pattern;
a first alignment mark formed in the patterned surface outside of the feature area, the first alignment mark formed of material having a substantially similar index of refraction as the formable material; and,
a second alignment mark embedded within the body of the template.

2. The imprint lithography template of claim 1, wherein the first alignment mark is positioned on the patterned surface to provide a reference of overlay error between second alignment mark and the feature area.

3. The imprint lithography template of claim 1, wherein the second alignment mark embedded within the body of the template is formed of material having a substantially different index of refraction as the formable material.

4. The imprint lithography template of claim 1, wherein the second alignment mark embedded within the body of the template and the first alignment mark formed in the patterned surface are positioned to provide at least one overlay alignment measurement.

5. The imprint lithography template of claim 1, wherein the feature area includes a plurality of recesses and protrusions.

6. The imprint lithography template of claim 1, wherein the feature area includes a substantially planar surface.

7. The imprint lithography template of claim 1, wherein the body is formed of material having a substantially similar index of refraction as the formable material.

8. The imprint lithography template of claim 1, wherein the feature area is formed of material having a substantially similar index of refraction as the formable material.

9. The imprint lithography template of claim 1, wherein the first alignment mark is formed of material substantially non-visible when subjected to a first wavelength.

10. The imprint lithography template of claim 9, wherein the second alignment mark is formed of material visible when subjected to the first wavelength.

11. The imprint lithography template of claim 10, wherein the feature area is formed of material substantially non-visible when subjected to the first wavelength.

12. The imprint lithography template of claim 1, wherein the body of the template is formed from a material selected from a group of materials comprising fused-silica, quartz, silicon, organic polymers, siloxane polymers, borosilicate glass, fluorocarbon polymers, metal, and hardened sapphire.

13. The imprint lithography template of claim 1, wherein the first alignment mark is formed from a material selected from a group of materials comprising fused-silica, quartz, silicon, organic polymers, siloxane polymers, borosilicate glass, fluorocarbon polymers, metal, and hardened sapphire.

14. The imprint lithography template of claim 1, wherein the first alignment mark and the body of the template are formed of substantially similar materials.

15. The imprint lithography template of claim 1, wherein the second alignment mark is formed of material selected from a group of materials comprising tantalum, tantalum nitride, tungsten, silicon carbide, amorphous silicon, chromium, chromium nitride, molybdenum, molybdenum silicide, titanium, and titanium nitride.

16. The imprint lithography template of claim 1, wherein the second alignment mark is embedded within the body of the template outside of the feature area.

17. The imprint lithography template of claim 1, wherein the second alignment mark is an implantation structure.

18. The imprint lithography template of claim 1, wherein the first alignment mark formed in the patterned surface is positioned in superimposition with the second alignment mark embedded within the body of the template.

19. An imprint lithography template for patterning formable material positioned on a substrate, comprising:
a patterned surface having a feature area with a plurality of protrusions and recessions;
a first alignment mark formed in the patterned surface outside of the feature area, the first alignment mark formed of material having a substantially similar index of refraction as the formable material; and,
a second alignment mark embedded within the body of the template and in superimposition with the first alignment mark;
wherein the first alignment mark is positioned on the patterned surface to provide a reference of overlay error between the second alignment mark and the feature area.

20. An imprint lithography template for patterning formable material positioned on a substrate, comprising:
a body having a first side and a second side;
a mold having a patterned surface, the mold positioned on the first side of the body, the patterned surface having a feature area with a plurality of protrusions and a recessions defining a first pattern;
at least one complementary alignment mark formed in the patterned surface outside of the feature area, the first alignment mark formed of material having a substantially similar index of refraction as the formable material; and,
at least one buried alignment mark embedded within the body of the template and positioned in superimposition with at least a portion of a corresponding complementary alignment mark;
wherein the corresponding complementary alignment mark is positioned on the patterned surface to provide a reference of overlay error between the buried alignment mark and the feature area.
